(19) United States
(12) Patent Application Publication
(10) Pub. No.: US 2018/0211313 A1
(43) Pub. Date: Jul. 26, 2018

(54) SYSTEMS, METHODS AND DEVICES FOR PROVIDING AND RECEIVING PLEDGES

(71) Applicant: Viswanatham Narahari, (US)

(72) Inventor: Viswanatham Narahari, Edison, NJ (US)

(21) Appl. No.: 15/878,380

(22) Filed: Jan. 23, 2018

Related U.S. Application Data
(60) Provisional application No. 62/449,567, filed on Jan. 23, 2017.

(51) Int. Cl. G06Q 40/02

(52) U.S. Cl. CPC G06Q 40/025

(57) ABSTRACT

Disclosed herein is are systems, methods, and devices for facilitating access to pledges of assets that can boost the users' creditworthiness or provide pledges to other users to increase such recipient users' creditworthiness. In an aspect, a system can employ a first determination component that determines first net worth data based on one or more first received asset pledge data and one or more first committed asset pledge data. In another aspect, the system can employ a transfer component that facilitates a receipt of one or more second asset pledge data or a commitment of at least a portion of the one or more first received asset pledge data.

### PRIORITY CLAIM

This application claims priority to U.S. Patent Application No. 62/449,567 filed on Jan. 23, 2017, and entitled “SYSTEMS, METHODS, AND DEVICES FOR PROVIDING AND RECEIVING PLEDGES”. The entirety of the aforementioned application is incorporated by reference herein.

### TECHNICAL FIELD

This application relates to systems and methods for connecting entities that seek to provide or receive pledges of assets with other entities that seek to receive or provide assets respectively.

### BACKGROUND

The activity of performing a financial transaction often includes the providing of a promise by one party in exchange for the providing of a promise by another party. For instance, a first party may agree to lend an amount of money to a second party in return for the second party paying a continuous coupon payment to the first party. Furthermore, a first party may require the second party to provide assurances that they will pay back the sum lent to the first party.

As such, a first party may accept a promise by the second party to repay the debt issued by the first party as well as pledged collateral or other such security alongside the promise to repay the debt. Furthermore, the first party may accept a secondary promise by a third party to repay the debt incurred by the second party should the second party default on its promise to repay the debt. In such instances, the second party is bolstering its credibility to repay the debt by providing promises, financial recourse, assurances, collateral, or additional party liability.

As such, most financial institutions assess a credibility or creditworthiness of a borrower or recipient of a transaction based on the recipient's capacity and ability to pay a debt or make good on an undertaking or obligation, credit history, cash flow history, cash flow projections for a secured revenue source, available collateral or security, financial statements, income tax returns, business plans and other such information. In some instances, a lending institution may allow for another individual or entity to guarantee or pledge support by promising to incur the debt liability of another in the event that the borrower cannot repay the debt.

Despite the traditional means for financial institutions to evaluate creditworthiness and credibility's of entities and individuals for eligibility of financial transactions, there is an absence of technological tools to assist the general population, organizations, and institutions to perform such activities in an up to date and efficacious manner. As such, there is a need for a solution to such problem.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, apparatuses, and/or computer-implemented methods that facilitate determining a similarity between texts comprising reference text.

According to an embodiment of the present invention, a system can comprise a memory that stores computer executable components and a processor that executes the computer executable components stored in the memory, wherein the computer executable components comprise a first determination component and a transfer component. In an aspect, a first determination component can determine a first net worth based on one or more first received asset pledge and one or more first committed asset pledge. In another aspect, a transfer component can facilitate a receipt of one or more second asset pledge or a commitment of at least a portion of the one or more first received asset pledge.

Additionally, a non-limiting embodiment provides for a method. In an aspect, the method can comprise determining, by a system comprising a processor, a first net worth based on one or more first received asset pledge and one or more first committed asset pledge. Furthermore, in another aspect, the method can comprise facilitating, by the system, a receipt or a commitment of one or more second asset pledge or at least a portion of the one or more first received asset pledge respectively. In yet another aspect, the method can comprise determining, by the system, an adjusted first net worth based on the receipt of the one or more second asset pledge or the commitment of the portion of the one or more first received asset pledge.

According to yet another embodiment, a computer program product is provided that can determine a first net worth based on one or more first received asset pledge and one or more first committed asset pledge. In another aspect, the computer program product can facilitate a receipt of one or more second asset pledge or a commitment of at least a portion of the one or more first received asset pledge.

### DESCRIPTION OF THE DRAWINGS

FIG. 1A illustrates a block diagram of an example, non-limiting system that can facilitate a user to increase its own or another user creditworthiness.

FIG. 1B illustrates an example matrix that can be employed by non-limiting system to facilitate a user to increase its own or another user creditworthiness.

FIG. 2 illustrates a block diagram of an example, non-limiting system that can facilitate a user to increase its own or another user creditworthiness.

FIG. 3 illustrates a block diagram of an example, non-limiting system that can facilitate a user to increase its own or another user creditworthiness.

FIG. 4 illustrates a block diagram of an example, non-limiting system that can facilitate a user to increase its own or another user creditworthiness.

FIG. 5 illustrates a block diagram of an example, non-limiting system that can facilitate a user to increase its own or another user creditworthiness.

FIG. 6 illustrates a block diagram of an example, non-limiting system that can facilitate a user to increase its own or another user creditworthiness.

FIG. 7 illustrates a block diagram of an example, non-limiting system that can facilitate a user to increase its own or another user creditworthiness.

FIG. 8A illustrates a block diagram of an example, non-limiting system that can facilitate a user to increase its own or another user creditworthiness.

FIG. 8B illustrates a block diagram of an example, non-limiting system that can facilitate a user to increase its own or another user creditworthiness.

FIG. 9 depicts a flow diagram of an example, non-limiting method for facilitating a user to increase its own or another user creditworthiness in accordance with one or more embodiments described herein.

FIG. 10 depicts a flow diagram of an example, non-limiting method for facilitating a user to increase its own or another user creditworthiness in accordance with one or more embodiments described herein.

FIG. 11 depicts a flow diagram of an example, non-limiting method for facilitating a user to increase its own or another user creditworthiness in accordance with one or more embodiments described herein.

FIG. 12 depicts a flow diagram of an example, non-limiting method for facilitating a user to increase its own or another user creditworthiness in accordance with one or more embodiments described herein.

FIG. 13 illustrates a block diagram of an example, non-limiting operating environment in which one or more embodiments described herein can be facilitated.

FIG. 14 illustrates a block diagram of an example, non-limiting operating environment in which one or more embodiments described herein can be facilitated.

### DETAILED DESCRIPTION

### Overview

Given the advent of peer to peer lending there is a marketplace for users to lend money to other users in arms-length transactions. However, a borrower's creditworthiness or credibility is still evaluated using antiquated techniques such as credit score's, credit history, age, employment, and income level. However, the most reliable and strong indicator of creditworthiness and credibility of a borrower or recipient of funds is a pledge of assets (e.g., collateral, real estate, cash, etc.), a personal guarantee, or the sharing of liability with others (e.g., through a third-party guarantee). This disclosure provides for a system that allows for users to receive and/or provide other users with pledges of support (e.g., assets, guarantees, cash, etc.) in order to obtain or provide a strong indicator of creditworthiness or credibility.

Given the advent of advanced social networks, users (e.g., people, organizations, entities, etc.) are connected socially. However, users are not connected by worthiness (e.g. financial worth, user wealth, etc.). As such, the disclosed systems, methods and devices provide mechanisms for users to connect with other users to share user worth (e.g., increase worth, decrease worth, pledge worth, etc.). In an aspect, the disclosed systems allow users to request pledges of worth from other users (e.g., increase a users' own worth by sourcing worth or pledges of worth from others), or to pledge its own worth to other users (e.g., increase its own risk by putting its worth at risk). For instance, user X may seek to obtain a loan from user Y, however User X may wish to secure a low interest rate for borrowing such funds from user Y. User Y may look to user X's credit score, state of employment, current savings, income level and other traditional factors to determine user X's creditworthiness. However, user X can utilize the system disclosed herein to receive pledges of cash, personal guarantee's, collateral or ownership of liability portions from numerous other users (e.g., family members, neighbors, friends, community members, kind strangers, etc.) to enhance its credibility and secure a lower coupon requirement (or other such more favorable terms) from user Y in order to borrow funds.

As such, disclosed herein is a platform that facilitates users to provide and/or receive pledge data representing pledges of support in the form of assets, personal guarantee's and other forms of collateralized obligation and/or assets to and/or from one or more other user. The disclosed system, provides the most reliable indicator of creditworthiness which are pledged assets and obligations by other users. Furthermore, by providing a peer to peer-based mechanism for providing or receiving collateral (e.g., assets) or promises to incur obligations to or from another user, the system provides a tool to strengthen financial transactions and increase financial confidence associated with various financial transactions.

For instance, a peer to peer based lending platform can deem a first borrower to have a greater creditworthiness than a second borrower if such first borrower evidences its pledges of collateral (represented by data) facilitated by the disclosed system and the second borrower evidences no such pledges of support or collateral. Furthermore, by utilizing the disclosed system to source pledges of support and enhance creditworthiness, a wide spectrum of users can gain access to financial markets to facilitate financial transactions despite having poor credit scores or other traditional indicators of creditworthiness. Additionally, those users whom pledge support to other users can spread their support amongst many users (e.g., family members) in as small or as large increments as desired. A user seeking to enhance its creditworthiness can essentially crowd-source collateral and third-party commitments to assume various liabilities in the event of default of the user.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The subject disclosure is directed to systems, devices, apparatuses, and/or computer-implemented methods that facilitate the ability to source or provide financial support to enhance creditworthiness. Financial support can take many forms such as a personal guarantee, a pledge of collateral (e.g., asset) or cash, or a promise to bear a portion of all financial liability of another. For instance, a user can pledge anything of value including, but not limited to; cash, real property, personal property, intellectual property, real estate, vehicles, inventory, stocks, bonds, equipment, intangible property, tangible property, machinery, fixtures, annuities, art, jewelry, watches, insurance policies, medical instruments, lottery tickets, wine collections, tires, art, pensions, IRA's, 401k's, investment funding, chattel paper, letters of credit, mortgage-backed-securities, commercial paper, equities, commodities, payment rights, anything that has revenue or a potential future earnings stream, contracts for purchase, purchase orders, loans made to other people, land, certificates of deposit, treasury certificates, assets owned, assets already pledged, homes (e.g., as demonstrated by a deed or title), collectibles/receivables, insurance policies, savings accounts, a secondary obligation, an indemnity, a pledge (e.g., conditional or unconditional), and/or future payments.

A first user (e.g., entity or individual) can utilize the systems, devices, and methods disclosed herein to transmit first pledge data representing a pledge value (e.g., commitment to transfer of an asset upon occurrence of a triggering) to a second user or receive pledge data representing a pledge value (e.g., a commitment to receive an asset upon occurrence of a triggering event) from a second or third user. The first user, by transferring pledge data representing a pledge of something of value to a second user can increase the worth (e.g., creditworthiness) of the second user but also increases the first user risk accordingly. The first user by receiving pledge data representing a pledge of value to be conditionally received from a third user can increase the first user worth data value while increasing the risk of the third user. The total worth (e.g., represented by assets, pledge receivables, and pledge liabilities) possessed by a respective user and the total risk born by a respective user can indicate a creditworthiness of such user. Furthermore, a user with a greater worth than risk (hereinafter referred to as positive net worth) can utilize such positive net worth to secure more favorable terms in a transactional arrangement (e.g., financial transaction, insurance transaction, healthcare transaction, etc.).

Furthermore, in an aspect, a user whom is associated with a greater risk amount as compared to a worth amount (e.g., hereinafter referred to as negative net worth) may secure less favorable terms in a transactional arrangement as compared to a user with a greater net worth. However, such user can utilize the disclosed systems, devices, and methods to procure pledges of value (e.g., represented by pledge data) from other users in order to increase its worth. As such, the disclosed systems, methods, and devices allow for users to source a wide array of resources to increase its own creditworthiness and contribute a wide array of resources to increase another users' creditworthiness. By increasing the creditworthiness of users, each user can have greater access and negotiation leverage with banks, mobile phone companies, insurance companies, landlords, government departments, lenders, and other organizations that use creditworthiness to transact goods, services, or instruments with a user.

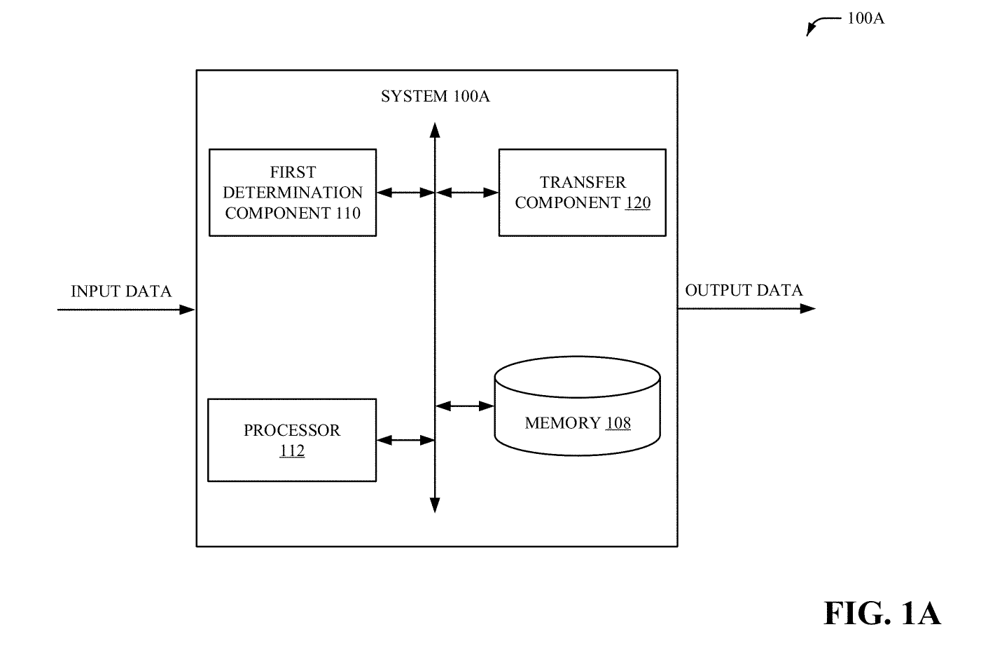

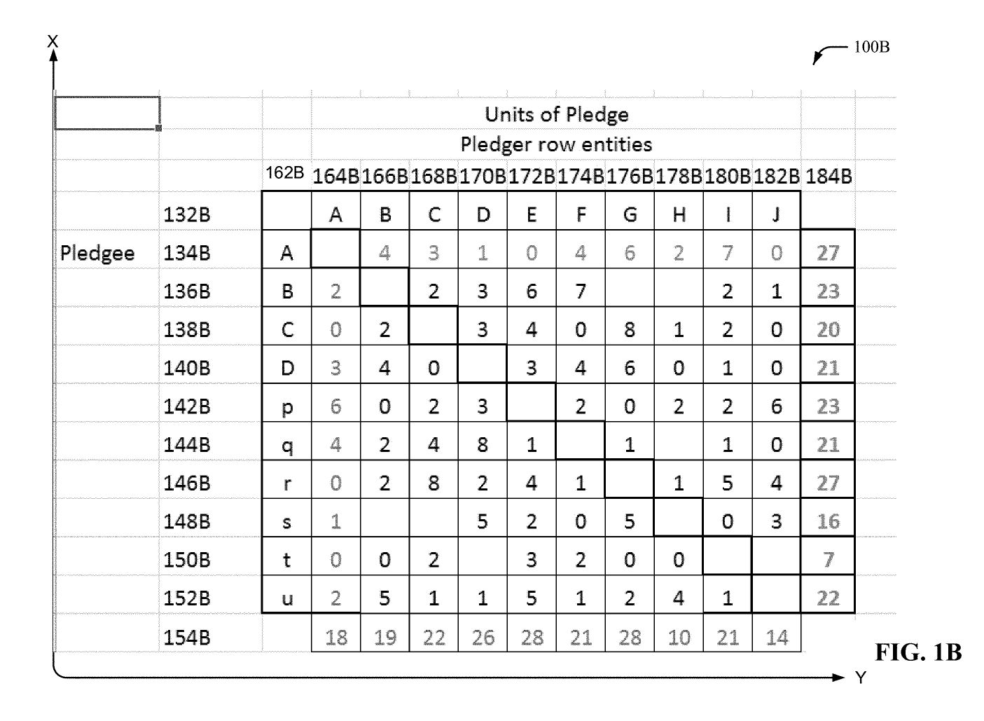

As shown in FIG. 1A, illustrated is system 100A configured to allow a user to access pledges of assets that can boost the users' creditworthiness or provide pledges to other users to increase such recipient users' creditworthiness. In an aspect, system 100A components can include or otherwise be associated with at least one processor 112 that can execute the computer executable components and/or computer instructions stored in memory 108. The processor 112 can execute a first determination component 110 and a transfer component 120 both component, of which, can be stored in memory 108.

In an aspect, first determination component 110 that determines a first net worth based on one or more first received pledge data (e.g., received by a first user) representing an asset pledge from another user (e.g., from another user to a first user) and one or more first committed pledge data (e.g., committed by a first user) representing an asset pledge from a first user to another user. In an aspect, first committed pledge data represents a pledge of an asset (e.g., promise to transfer the asset) that a first user has given to a second user. If the first user has given multiple pledges (e.g., to multiple users) then the first committed asset pledge can be the aggregate of all pledge commitments. In another aspect, first received pledge data can represent be an aggregate of all the pledges of an asset (promise to transfer assets to the first user) received by the first user or committed to the first user from other users (including pledges the first user may have committed to itself).

Thus, if the first user has received pledge commitments from nine different users (e.g., three separate family members, two friends, and four strangers) then the aggregate of such received asset pledge would be the sum of all pledges from such nine users. A user can source pledge data representing asset pledges from other users by providing identification data representing details about their current net worth and also detailing track record information (e.g., previous deals where the user has repaid a debt, etc.), providing testimonials/referrals, and/or detailing the transaction (e.g., terms of a loan, summary of a real estate transaction, pro-forma of a start-up, etc.) to which their aggregate requested asset pledges will go to support.

In another aspect, system 100A can employ a transfer component 120 that facilitates a receipt of one or more second pledge data representing a commitment of at least a portion of the one or more first received asset pledge. The transfer component 120 can allow a user to transmit pledge data to another user representing an asset pledged as a commitment to another user or to request, receive and/or source pledges from other users. The commitment of asset pledges (e.g., transferring pledge data) by a first user to a second user causes the first user to bear additional risk (e.g., taking on a commitment, obligation, or liability) while the receipt of an asset pledge by the second user from the first user bears added value of worth to the second user (e.g., receiving something of value from another). Similarly, the receipt of pledged asset data by a first user from a third user will ascribe additional worth to the first user while ascribing additional risk to the third user. In some instances, a user may input more worth into the system to themselves. For instance, the first user may input into system 100A a pledge of assets to its user account in order to increase its worth (e.g., the first user may deposit cash, property titles, etc. into its account to enhance its own creditworthiness on the system 100A).

As such, a first user can execute (e.g., using one or more processor) system 100 on a first device and a second user can execute (e.g., using one or more processor) system 100 on a second user device that is different from the first user device. As such, the first user can transfer first pledge data to the second user representing a commitment to pledge an asset (e.g., cash) to the second user should the user perform a triggering event (e.g., defaulting on a load). As such the first user's worth is decreased (e.g., because of the commitment of a pledge to the second user) and the second user's worth is increased (e.g., because of the receipt of a pledge commitment. In another aspect, firs user device execute system 100 (and system 100 components) to solicit or generate pledge commitments from a third user device. As such, the first user device worth can be increased based on the pledge commitments received from other user devices.

Accordingly, system 100 can facilitate a transmission (e.g., using transfer component 120) of pledge data between user devices. Furthermore, system 100 can facilitate a determination (e.g., using first determination component 110) and an adjusted determination based on an occurrence of updated pledge data transmission of net worth data associated with a user device. Thus, each user device can be identified to carry risk data representing a level of riskiness (e.g., if a user device provides or receives a pledge to and/or from such user device). Furthermore, system 100 components can be executed by network components such as one or more server device to facilitate a transmission of pledge data between user devices.

In another aspect, system 100 can utilize blockchain implementations to store transaction data associated with a transfer of pledge data between user devices. Furthermore, in one or more non-limiting embodiments, one or more smart contracts can be provided on a blockchain and configured to perform one or more operations to facilitate blockchain-based validation techniques. For instance, a smart contract can be a computer application programmed to process one or more transaction representing a transmission of pledge data from a first user device to a second user device. As such, the transmission of pledge data can be represented as a transaction that is transmitted to a computer application and executes an action or operation or brings about a result based on the smart contract computer application. For instance, system 100 can identify blockchain address data associated with a first user.

Furthermore, a smart contract can be generated by system 100 based on a transmission of pledge data between a first user device and a second user device and based on conditions associated with such transmission of pledge data. Also, system 100 components can transmit an asset associated with the pledge data upon the occurrence of a stated event in connection with the smart contract. Thus, if a user defaults on a debt obligation and such obligation was supported by a pledge of assets from other user devices, then such pledged assets can be transmitted (e.g., execution of ownership transfer documents) and registered using the smart contract. Furthermore, the occurrence of the transaction (e.g., transfer of assets) can be validated based on its recordation onto the blockchain.

In some non-limiting embodiments, a blockchain record may be associated with real-world accounts tied to users pledged assets and transactions associated with such pledged asset or activity related to the pledged asset. A smart contract can be generated and provided on a blockchain to facilitate blockchain based validation of whether a user whom pledges an asset is an authorized user, owner, or party with rights to the pledged asset has performed an action related to the pledged asset (e.g., notarization of a document associated with the pledged asset). In an aspect, a user pledging asset can utilize a private key in its possession in combination with a public key to record a transaction (e.g., pledging of an asset by provisioning pledge data or receiving a pledged asset by receiving pledge data) associated with the pledged asset.

In another aspect, system 100 can employ components to transform data regarding assets (e.g., usage trends, life expectancy of asset, depreciation of asset, volatility of asset value, subjective asset measurements, objective asset measurements, cash flow potential of an asset, and other such measurements) into pledge data associated with a value. For instance, system 100 can employ components to monitor an asset use (e.g., a boat, item of machinery, etc.) and transform data associated to the asset into pledge data representing a valuation of the asset based on such asset use. In an aspect, issues associated with the asset can be automatically detected (e.g., by one or more sensor device associated with the asset, by sourcing one or more subset of data associated with the asset health or maintenance, or by sourcing data from a special purpose machine that monitors the activity of an asset such as machine to detect imperfections within a diamond or gold) and such issues can be transmitted to a notification node to identify each issue as it arises.

Furthermore, such asset data can be stored in an inventory database of a computing device (e.g., server device), where such asset data can be adjusted, modified, and updated based on asset use. In another aspect, the asset data can be transformed (e.g., by one or more processors) into pledge data representing a current valuation associated with such asset that has been pledged (e.g., as a guarantee, collateral, etc.) on behalf of another user. Accordingly, data representing physical asset attributes can be transformed and modified into pledge data using system 100 components. In another aspect, asset data can be validated by comparing asset data and pledge data to a set of validation data representing authentic and reputable information related to an asset such as asset appraisals, third party assessments of an asset, asset title transfers, asset valuations as per legal settlement (e.g., patents) results, liabilities associated with assets that are part of the public record, asset market values based on publicly available information (e.g., market information, quarterly reports, etc.), and other such validation data.

In another non-limiting embodiment, the systems disclosed herein can utilize artificial intelligence to deploy trained classifiers for performing probabilistic determinations or statistical-based determinations associated with gauging a pledged asset value. Furthermore, such artificial intelligence techniques can facilitate predictions as to creditworthiness of a user based on worth data, asset data, pledge data, and other subsets of data sourced, generated or stored within the systems disclosed herein. In an aspect, a classifier can be a function that maps an input attribute vector to a confidence that the input belongs to a class. Such classification can employ a probabilistic and/or statistical based analysis to infer an action that a user seeks to automatically be performed. For instance, a first user may seek to utilize system 100 to identify all candidate users from which they can procure pledge data representing pledges of assets to the first user.

The user can utilize a classifier to map input data associated with a set of users to identify whether those users have a higher likelihood or probability of providing pledge data to the first user. For instance, candidate users may historically provide pledge data to other users that have similar worth data values (e.g., a first classifier) as the first user, a similar historical track record of satisfying obligations (e.g., a second classifier) associated with such received pledge data, or a similar use (e.g., third classifier) of received pledge data (e.g., use to as collateral for obtaining an inventory financing loan). In such instances, the attributes can be information received from access points, servers, components of wireless communication networks and other such sources and the classes can be categories or areas of interest (e.g., levels of priorities). A support vector machine is an example of a classifier that can be employed, which can identify a hypersurface in space of possible inputs that can be utilized for testing data that is near or identical to training data.

In another aspect, other directed and undirected model classification approaches (e.g., Bayesian networks, decision trees, neural networks, fuzzy logic models, probabilistic classification models, etc.) can be utilized to perform artificial intelligence based predictive evaluations associated with pledge data and systems disclosed herein. Furthermore, classification models can include statistical regression to develop models of priority associated with pledge data. In another aspect, artificial intelligence based systems, components, etc. can employ classifiers that are explicitly trained (e.g., via generic training data, observing characteristics of communication equipment, a server, etc.) or implicitly trained to perform learning within classifier constructors and feature selection models. Therefore, a classifier can be used by artificial intelligence systems disclosed herein to automatically learn and perform a number of functions beyond transforming asset data to pledge data, transmitting pledge data between users, and predicting candidates for receiving pledge data and whom can provision pledge data.

Turning now to FIG. 1B, illustrated is a non-limiting example of a pledge matrix of system 100A that demonstrates a mechanism by which the system can facilitate the sourcing of pledged assets and the providing of pledge commitments to users. At row 132B, provided are a set of entities A (shown at 164B), B (shown at 166B), C (shown at 168B), D (shown at 170B), E (shown at 172B), F (shown at 174B), G (shown at 176B), H (shown at 178B), I (shown at 180B), J (shown at 182B), wherein each entity can be a number of user types (e.g., an individual, a person, an organization, an institution, an agency, a company, a group of individuals, a commodity, a stock, a fund, a fixed property or anything that has a deemed value equal to or between 0 and infinity, etc.). Each entity can utilize system 100A to pledge an asset as a commitment or source assets. For instance, entity/user B as a pledgee (shown at row 136B) has received a pledge of 2, 2, 3, 6, 7, 0, 0, 2, 1 from Users A, C, D, E, F, G, H, I, and J respectively (where A, B, C, D, E, F, G, H, I, and J are all pledgor's of assets). Thus, user B has total received pledges (of assets of value) equal to 23 units (shown at the intersection of rows 136B and column 184B).

Furthermore, in an aspect, user B (shown at 136B) has also pledged units of value in amounts of 4, 2, 4, 0, 2, 2, 0, 0, and 5 from user's A (shown at 134B), C (shown at 138B), D (shown at 140B), p (shown at 142B), q (shown at 144B), r (shown at 146B), s (shown at 148B), t (shown at 150B), and u (shown at 152B) respectively (where A, B, C, D, p, q, r, s, t, and u are all pledgee's of assets). Thus, entity B has pledged to other users' commitments aggregating to 19 units of value. As such, B's worth is 23 units (23 received asset pledges) and risk is 19 units (19 units committed to other users) placing user B's net worth at 4 units (23 units received−19 units committed to others=4 units). Therefore, user B has a positive net worth and is deemed to have a greater creditworthiness than other users with less than 4 units of net worth. Accordingly, B is deemed less creditworthy than a user with a greater net worth than 4 units. For instance, user A has a net worth of 9 units (e.g., worth of 27−risk of 18=9 units), which is more than user B's net worth of 4 units therefore user A has a greater creditworthiness than user B. FIG. 1B illustrates an aggregate risk of each pledger user at reference numeral row 154B and an aggregate worth of each pledgee at reference numeral column 184B.

Also, system 100A and other embodiments of the system disclosed herein allow for the continuous sourcing and committing of pledges. As such a user can increase its creditworthiness or decrease its creditworthiness as it receives or commits more pledges respectively. For instance, if User p pledges 4 units (e.g., transmits pledge data representing an asset worth four pledge units) to user B, then user p will increase its risk by 4 pledges and User B will increase it's worth by 4 units. Accordingly, User p's net worth (e.g., represented by net worth data or data values) will fall by 4 units to zero, and user B's net worth will increase by 4 units to 8 units (e.g., 4 units+4 units=8 units). As such, user B's creditworthiness will increase and although still be less than user A, the differential in margin between user A and user B's creditworthiness will be 1 unit (9 units associated with user A and 8 units associated with user B). Therefore, user A and user B will have a similar creditworthiness to be taken into account by various entities proposing transactions or receiving proposed transactions to/from user A and user B.

In an aspect, each pledge unit can be a standardized unit of value associated with an underlying asset that is pledged. For instance, in a non-limiting example, a pledge unit can equal ten thousand US Dollars. Thus, one pledge unit can be granted to a user based on such user receipt of a pledge of ten thousand US Dollars or a pledge of an asset (e.g., patent, boat, precious metal, cryptocurrency, etc.) worth ten thousand US Dollars. Furthermore, systems disclosed herein can allow for efficient access of data due to data access patterns of data requiring only access to summary pledge. For instance, a transmission of several sets of pledge data between various users can be reflected in summarization data (e.g., a current pledge worth) such that a memory only need access summarization data rather than a large set of pledge data representing each individual transaction (e.g., all transmission of pledge data). As such, a memory need access only summarization data rather than all historical pledge data transactions. As such, the pledge data access patterns allow for faster data access speeds of data stored in memory and/or cache of a device employing systems disclosed herein. Furthermore, in one or more aspect, pledge data transactions can be stored on a blockchain implementation associated with systems disclosed herein. Furthermore, the most current block of the chain can include verifiable summary data representing all previous pledge data transactions.

In an aspect, systems disclosed herein can facilitate a user to enhance its creditworthiness based on having pledges of assets assigned to such user. By enhancing a creditworthiness, a user can secure financing with greater ease (e.g., get loans faster), secure better terms on financial transactions (e.g., get a greater loan amount, interest rate, payment terms, etc.), be deemed as a more secure individual for purposes of conducting a transaction (e.g., granting an insurance policy, loan, equipment, lease, mortgage, etc.). Furthermore, system 100A facilitates the pledging of assets that have a value and are legally “on the hook” as collateral for a financial transaction. As such there is little ambiguity from a creditor's viewpoint as to where to go for recourse and what type of recourse is provided. In some instances, system 100A can provide escrow mechanisms to place pledged assets or items associated with ownership of pledged assets into an account that can be distributed to a creditor based on escrow terms or pursuant to an escrow agreement.

In another aspect, aside from transmission of pledge data, systems disclosed herein can allow for a generation and transmission of obligation data such as a first user undertaking a debt obligation to a second user and the second user transmitting loan data to the first user. In an aspect, a transmission of obligation data and loan data can be coupled (e.g., using system 100 and/or 200 components) to pledge data such that the pledge data and obligation to transfer an asset in accordance with the pledge terms can be assigned to another user (e.g., second user) transmitting loan data to a first user.

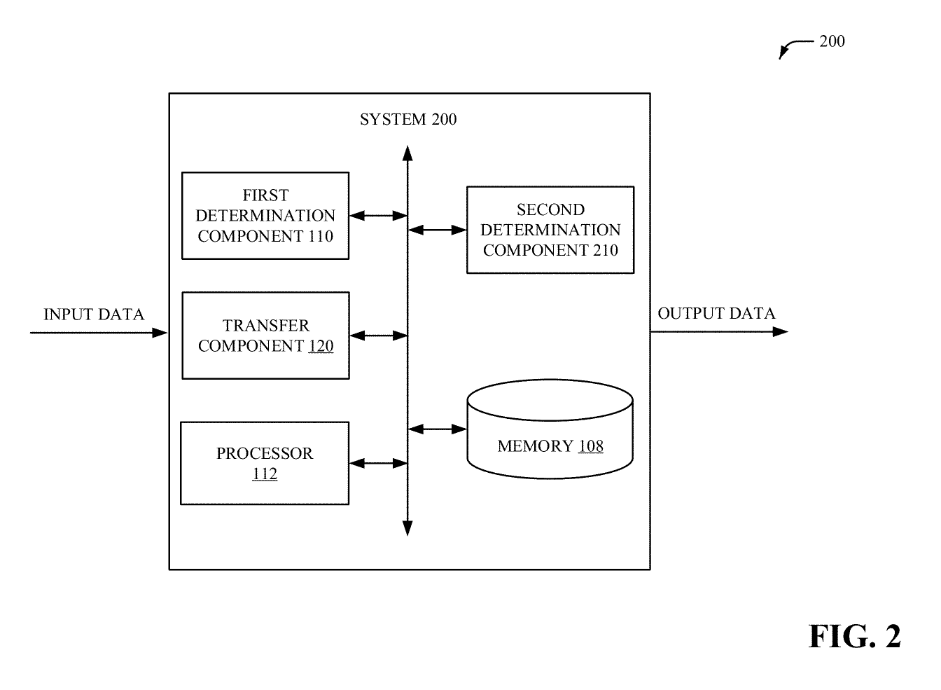

Turning now to FIG. 2, illustrated is a non-limiting example of a system 200 configured to allow a user can access pledge data representing pledges of assets that can boost the users' creditworthiness or provide pledge data to other users to increase such recipient users' creditworthiness. Repetitive description of like elements employed in respective embodiments of systems and interfaces described herein are omitted for sake of brevity. In an aspect, system 200 can comprise first determination component 110, transfer component 120, and second determination component 210. In an aspect, second determination component 210 can determine an adjusted first net worth data based on the receipt of the one or more second asset pledge or the commitment of the portion of the one or more first received asset pledge. As such, the net worth (e.g., represented by worth data also referred to as net worth data) of a user can change as the user bears more risk (e.g., undertakes more pledge commitments) or ascribes more value (e.g., receives more pledges). In an aspect, second determination component 210 can adjust (e.g., calculate an increase or decrease in user net worth) each user net worth (e.g., represented by worth data) as the committing and receiving pledge activities occur.

In a non-limiting embodiment, system 200 can employ determination component to determine a net worth of a first user based on first pledge data (representing pledges received) having a value of X less second pledge data (representing pledges provisioned to other users) having a value of Y. Where X is greater than Y, the first user is determined (e.g., using determination component 110) to have a positive net worth (represented by worth data). Where X is less than Y, the first user is determined to have a negative net worth. In an instance, the system can employ transfer component 210 to receive third pledge data (representing new and additional pledges received) having a value of A from other users and provision fourth pledge data (represented new and additional pledges provisioned to other users) having a value of B to other users. As such, second determination component 210 can adjust the worth data (representing a net worth) of first user to equal (X+A) less (Y+B). As such, if (X+A) is greater than (Y+B) then the worth of the first user is positive and if A is greater than B then the worth of first user has increased from the previous worth (e.g., represented by worth data).

Accordingly, system 200 can adjust (using second determination component 210) the worth of a user within system 100 and 200. In an aspect, system 200 can include a platform, by which, several users can provision and receive pledge data to and from one another. Furthermore, system 100 and 200 can utilize artificial intelligence techniques to predict which user (e.g., represented by user devices) are likely to have an increase in net worth or a decrease in net worth based on pattern recognition associated with pledge data activity, financial behaviors, and other sourced data.

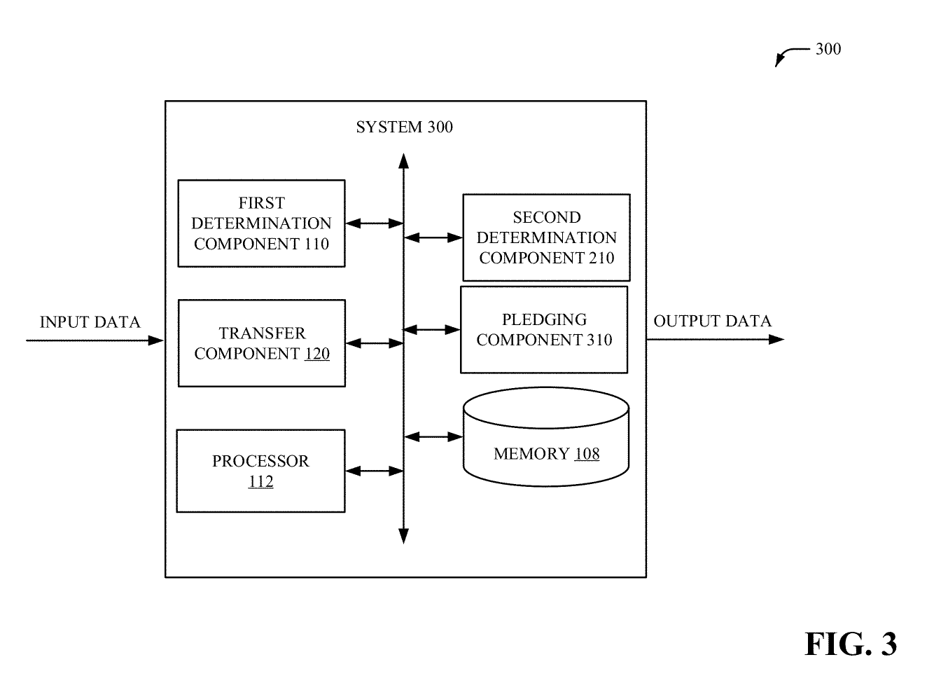

Turning now to FIG. 3, illustrated is a non-limiting example of a system 300 configured to allow a user can access pledges data representing pledges of assets that can boost the users' creditworthiness or provide pledge data to other users to increase such recipient users' creditworthiness. Repetitive description of like elements employed in respective embodiments of systems and interfaces described herein are omitted for sake of brevity. In an aspect, system 300 can comprise first determination component 110, transfer component 120, second determination component 210, and pledging component 310. In an aspect, pledging component 310 can facilitate a transmission of pledge data representing at least a portion of the first net worth (e.g., transmitting worth data) in exchange for an item of value. The pledging component 310, by allowing for the transmission of pledge data and worth data, can facilitate the negotiation and execution of a transaction utilizing metrics such as a user net worth in order for such user to obtain an item or attain a financial instrument of value.

For instance, a first user device can promise to pledge at least a portion of its net worth to a second user device or other such party in return for a borrowed sum of money. In another instance, a first user can promise to pledge its net worth (e.g., net worth data) in order to obtain rights to an item of value (e.g., right to make, use, practice or sell an invention disclosed in a patent). In yet another instance, the system 300 can employ pledging component 310 to allow a user to qualify for a re-financing of a property (e.g., multifamily residential property owned by the user). Accordingly, system 300 can employ pledging component 310 to execute a transaction that pledges an asset (e.g., promises to assign title to an asset or ownership of a physical asset or net worth data associated with such items) or places an asset in escrow or custodianship with a third-party entity. Thus, instead of the user pledging a personal or corporate guarantee (e.g., the pledge of personal or corporate assets), the user can pledge its net worth data associated with its assets (e.g., received asset pledges less pledged asset commitments) residing at system 300. Thus, system 300 can provide a marketplace for sourcing and providing asset pledges but also for storing pledges that can be deployed in various transactions.

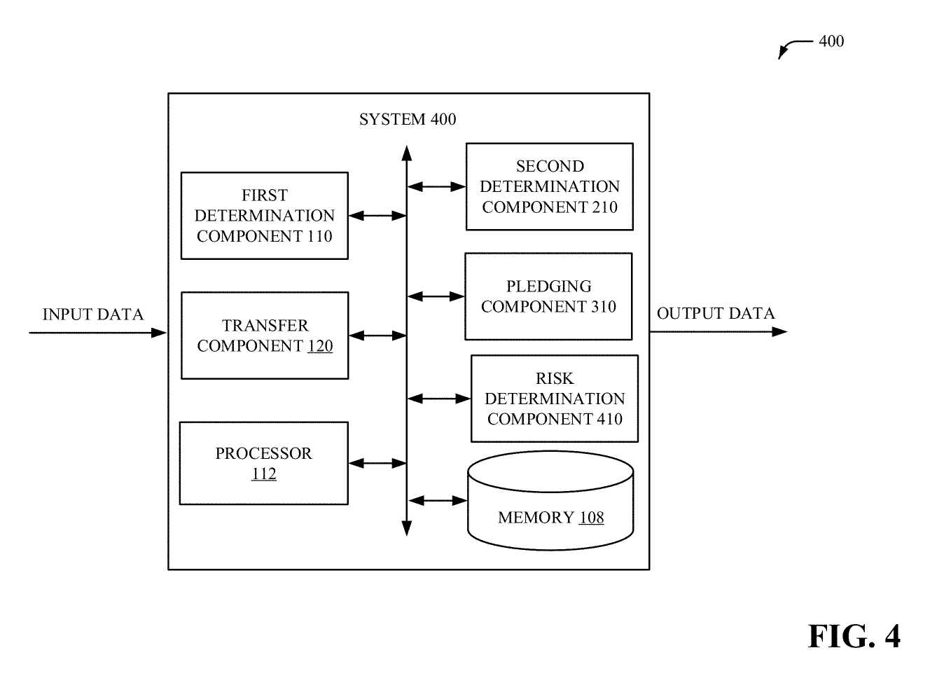

Turning now to FIG. 4, illustrated is a non-limiting example of a system 400 configured to allow a user can access pledge data representing pledges of assets that can boost the users' creditworthiness or provide pledge data to other users to increase such recipient users' creditworthiness. Repetitive description of like elements employed in respective embodiments of systems and interfaces described herein are omitted for sake of brevity. In an aspect, system 400 can comprise first determination component 110, transfer component 120, second determination component 210, pledging component 310, and risk determination component 410. In an aspect, risk determination component 410 determines a risk level associated with the first net worth data based on a comparison of the one or more first received asset pledge data to the one or more first committed asset pledge data. Thus, risk determination component 410 facilitates the determining of one or more users risk level based on committed asset pledge data. For instance, if a user has committed more asset pledges than its worth (e.g., represented by a negative net worth data), that user has a risk that has surpassed its worth and is deemed lacking creditworthiness. The degree to which a user lacks creditworthiness can be correlated with the level of risk associated with such user.

Furthermore, a risk level (e.g., represented by risk data) can be determined (e.g., using risk determination component 410) based on other factors as well as asset pledges committed. Other such factors that can be considered by risk determination component 410 can include any obligation data, liability data, or data representing issues with an asset such as contests to title ownership of a pledged title (e.g., liens, unclear title, chinks in a chain of title ownership, lack of robust documentation, etc.), liquidity of the asset pledged, type of asset pledged, and other such factors. In an aspect, cash pledge commitments and cash pledges received have a high confidence level for determination of risk and worth. In another aspect, risk determination component 410 can convey a confidence level of risk and worth (e.g., represented by risk data or a risk score) as well as provide a more detailed analysis of the determination techniques utilized to determine such risk and worth as well as net worth.

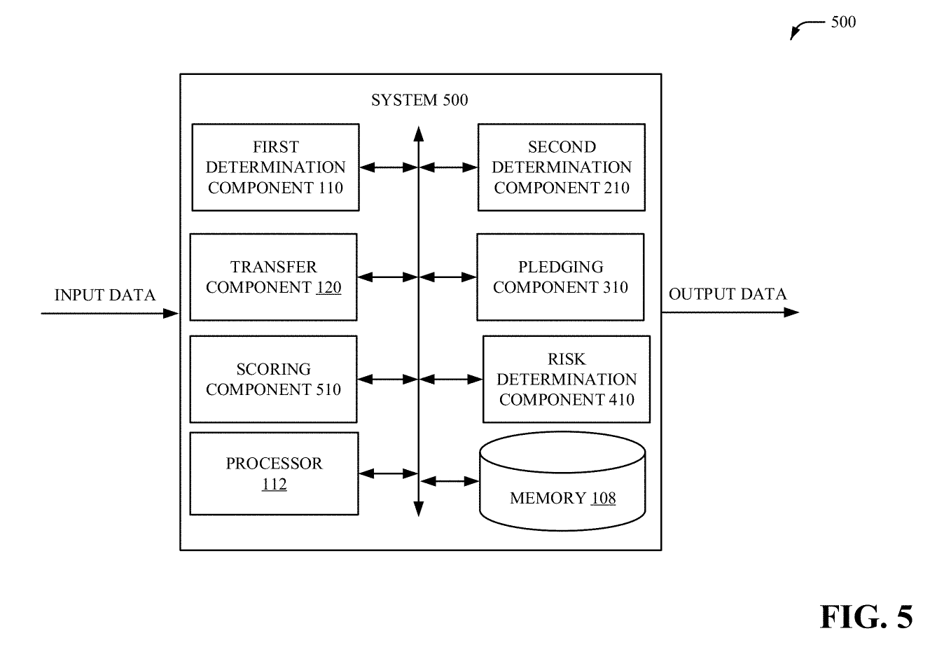

Turning now to FIG. 5 illustrated is a non-limiting example of a system 500 configured to allow a user can access pledge data representing pledges of assets that can boost the users' creditworthiness or provide pledge data to other users to increase such recipient users' creditworthiness. Repetitive description of like elements employed in respective embodiments of systems and interfaces described herein are omitted for sake of brevity. In an aspect, system 500 can comprise first determination component 110, transfer component 120, second determination component 210, pledging component 310, risk determination component 410, and scoring component 510. In an aspect, scoring component 510 can further comprise a scoring component that determines a credibility score associated with the first net worth based on the risk level (e.g., risk level data). In an aspect, a user can be associated with a score (e.g., using scoring component 510). The score can be used as indicia of creditworthiness of a user (and user profile) within system 500. As such, scoring component 510 can base the score on factors such as risk data, worth data, net worth data, track record (e.g., or repayment, etc.), or other intake information of each respective user to determine a score.

For instance, in an aspect, system 500 can deploy scoring component to determine a score of a first user, wherein the score represents the users' creditworthiness (e.g., credibility to satisfy pledges granted or credibility to satisfy obligations tied to pledges received and dependent on the first user satisfying such pledges). If a first user has a net worth of zero then scoring component can assign a low score to such first user indicating they have a low creditworthiness. In an instance, other users can utilize the score to assess whether to pledge assets to such user or place confidence in pledges provisioned from such user. Furthermore, in an aspect, system 500 can implement features that preclude a user with a negative net worth from taking on more liability based on a set of requirement data that instruct the system to disallow any additional liability undertakings to take place if a user is associated with score below a threshold value.

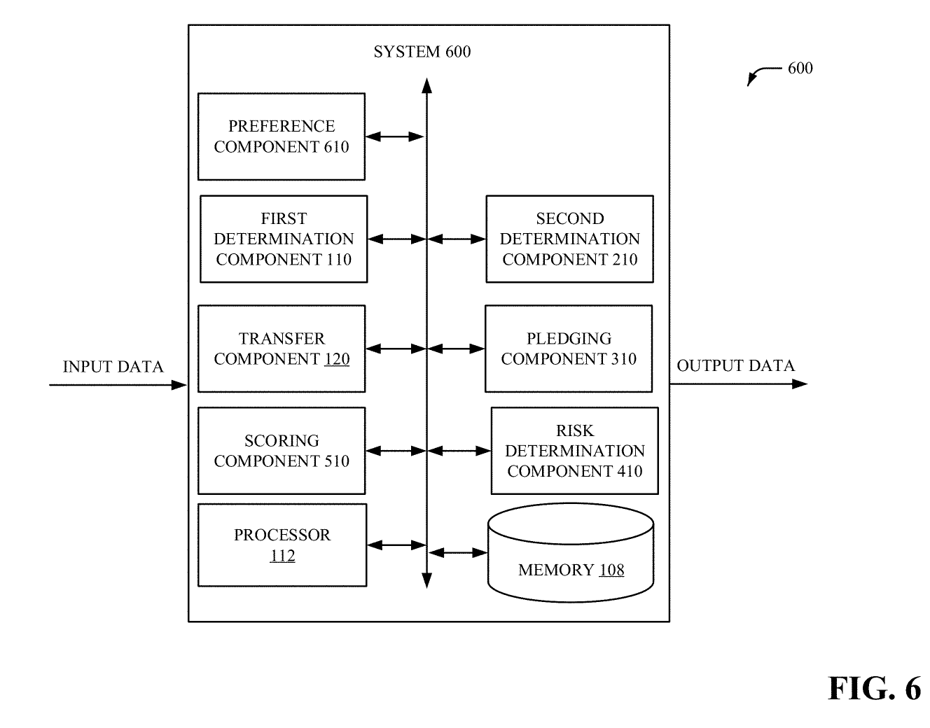

Turning now to FIG. 6 illustrated is a non-limiting example of a system 600 configured to allow a user can access pledge data representing pledges of assets that can boost the users' creditworthiness or provide pledge data to other users to increase such recipient users' creditworthiness. Repetitive description of like elements employed in respective embodiments of systems and interfaces described herein are omitted for sake of brevity. In an aspect, system 600 can comprise first determination component 110, transfer component 120, second determination component 210, pledging component 310, risk determination component 410, scoring component 510, and preference component 610.

In an aspect, preference component 610 can facilitate a selection of one or more pledge feature from a set of pledge features, wherein the set of pledge features can comprise a pledge limit, an asset class associated with a proposed pledge, a pledge hierarchy, a joint liability pledge, or a several liability pledge. Accordingly, preference component 610 can present features associated with each pledge (represented by pledge data) to define the terms of the pledge (e.g., contingencies, conditions, entitlements, apportioning, obligations, etc.). For instance, preference component 610 can present features that allow the definition or description of the pledged asset (e.g., physical asset, intangible asset, pledged inventor, pledged receivable, pledged real estate, etc.), a definition of margin collateral, indemnifications, and other such terms.

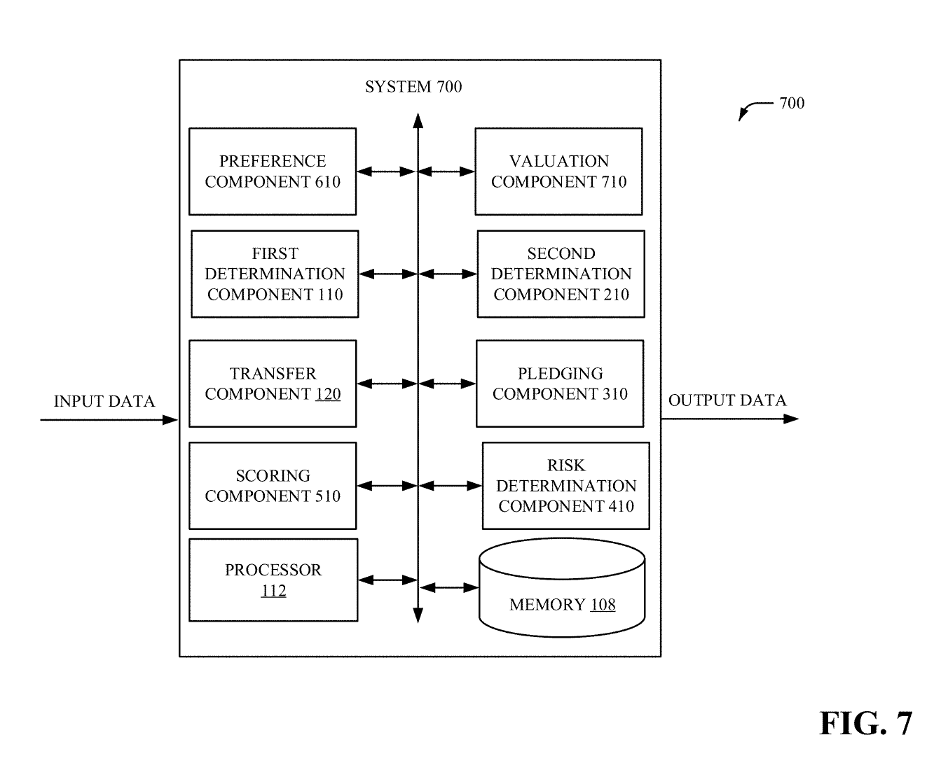

Turning now to FIG. 7 illustrated is a non-limiting example of a system 700 configured to allow a user can access pledge data representing pledges of assets that can boost the users' creditworthiness or provide pledges to other users to increase such recipient users' creditworthiness. Repetitive description of like elements employed in respective embodiments of systems and interfaces described herein are omitted for sake of brevity. In an aspect, system 700 can comprise first determination component 110, transfer component 120, second determination component 210, pledging component 310, risk determination component 410, scoring component 510, preference component 610, and valuation component 710.

In an aspect, valuation component 710 can assign a first value (e.g., represented by a data value) to the one or more first received asset pledge, a second value to the one or more first committed asset pledge, a third value to the one or more second received asset pledge and a fourth value to the portion of the one or more first received asset pledge, wherein the first net worth is based in part on the first value and the second value. In an aspect, valuation component 710 can utilize a variety of valuation mechanisms to value the pledged asset. For instance, valuation component 710 can utilize a discounted cash flow analysis, a comparable analysis, a precedent transaction analysis, an “ability to pay” analysis, a market approach, a cost approach, an income approach, sum of part valuation, transaction comparable, trading comparable, appraisal approaches, and other such techniques to ascribe a value to a pledged asset. Furthermore, in a non-limiting embodiment, a user can select (e.g., using preference component 610) a valuation methodology to implement for use in valuing (e.g. using valuation component 710) a pledged asset.

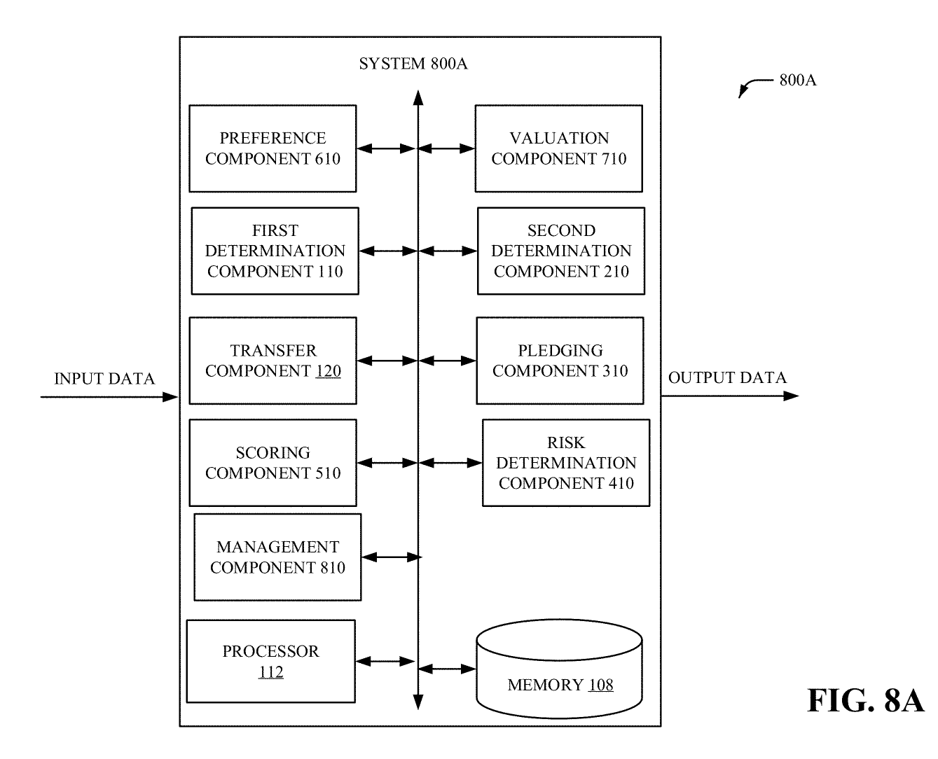

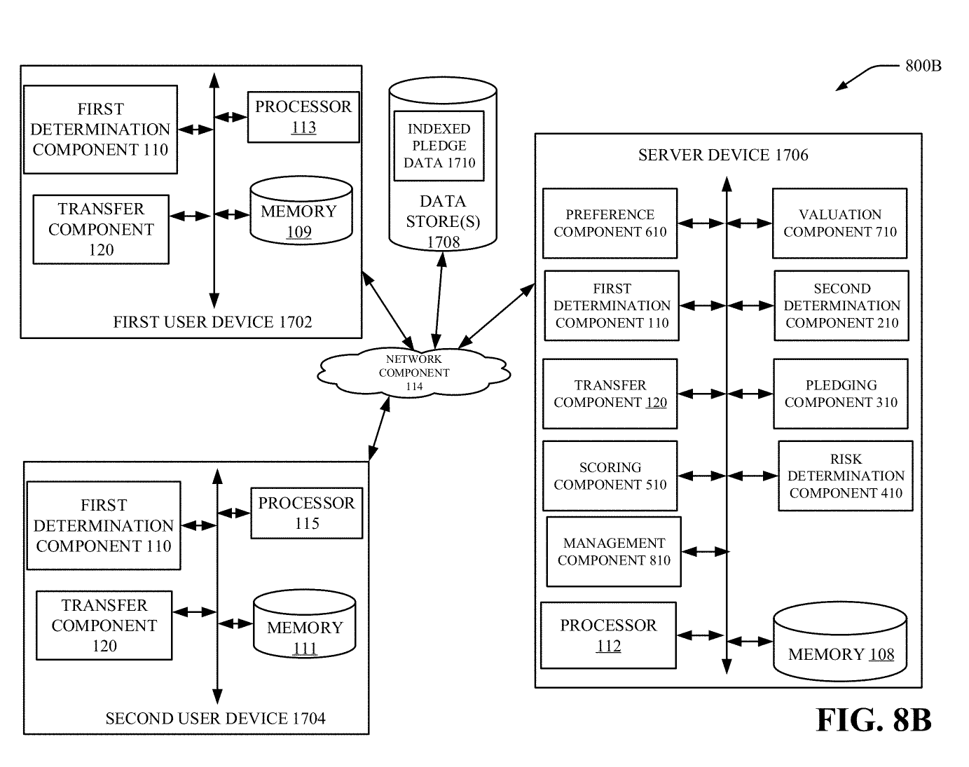

Turning now to FIG. 8A illustrated is a non-limiting example of a system 800A configured to allow a user can access pledge data representing pledges of assets that can boost the users' creditworthiness or provide pledge data to other users to increase such recipient users' creditworthiness. Repetitive description of like elements employed in respective embodiments of systems and interfaces described herein are omitted for sake of brevity. In an aspect, system 700 can comprise first determination component 110, transfer component 120, second determination component 210, pledging component 310, risk determination component 410, scoring component 510, preference component 610, valuation component 710, and management component 810.

In an aspect, management component 810 facilitates a receipt as per a respective arrangement the one or more first received asset pledge, the one or more first committed asset pledge, the one or more second received asset pledge or the portion of the one or more first received asset pledge. Accordingly, management component 810 can facilitate a management of pledged assets through any of a numerous means of management. For instance, an escrow account can be utilized to hold assets until a transaction term is over or in case disbursement is required pursuant to escrow terms. Furthermore, a trust can be utilized to hold an asset pledge or an executed document (e.g., pledge agreement, certificate, letter of credit, letter of authority, etc.) can evidence the pledging of an asset. In another aspect, management component 810 can employ a management tool to facilitate the management of the asset pledges by a user of system 800 or any of the system embodiments disclosed herein.

Turning now to FIG. 8B illustrated is a non-limiting example of a system 800B configured to allow a user can access pledge data representing pledges of assets that can boost the users' creditworthiness or provide pledge data to other users to increase such recipient users' creditworthiness. Repetitive description of like elements employed in respective embodiments of systems and interfaces described herein are omitted for sake of brevity. In an aspect, system 700 can comprise first determination component 110, transfer component 120, second determination component 210, pledging component 310, risk determination component 410, scoring component 510, preference component 610, valuation component 710, and management component 810.

In an aspect, system 800B includes a first user device 1702 comprising first determination component 110, transfer component 120, processor 113, and memory 109. In an aspect, first user device can execute (e.g., using processor 113) any of system 800B components (e.g., where system components can be packaged within an application executing on first user device 1702). In an aspect, first user device 1702 can transmit pledge data to second user device 1704 and/or receive pledge data from second user device 1704. In an aspect, first user device 1702, second user device 1704, data store 1708, and server device 1706 can transmit data to/from one another via network component 114. In an aspect, network 114 can include one or more configurable resources such as network devices network bandwidth, server devices, virtual machines, services, memory devices, storage devices, and other resources that can be provided to several user devices (e.g., first user device 1702, second user device 1704, etc.) and utilized by such user devices with minimal management effort from the administrator.

In an aspect, the user devices can access indexed pledge data 1710 from data store 1708 to facilitate determinations related to receiving or provisioning pledge data. Furthermore, such data store 1708 can be a blockchain-based storage or containment mechanism, a database, or other such storage mechanism. In an aspect, asset data, risk data, score data, and other such data can be stored in data store 1708. Furthermore, data accessed from data store 1708 can be transformed into pledge data, updated based on newly received data, or combined to generate integral data points that convey meaning related to pledged assets. In another aspect, server device 1706 can include one or more of system 800A components and be utilized to perform back-end operations to increase the processor speed and efficiency of operations associated with first user device 1702 and second user device 1704. In another aspect, second user device 1704 can include processor 115 and memory 111. In an aspect, first user device 1702 and second user device 1704 can include front-end components such as interface components to allow for display of system 800B graphics and features. Furthermore, such user devices can include input reception components (configured to receive input from touch screens, keyboards, etc.) and communication components (e.g., to interact with network 114) to facilitate communication with back-end system components such as those stored on server device 1706. In another aspect, devices in system 800B can include data loading components, data modeling components, query components, rendering components (e.g., data visualization renderings) and other such components to facilitate use of data (e.g., pledge data, asset data, risk data, etc.) within system 800B (e.g., from data store 1708).

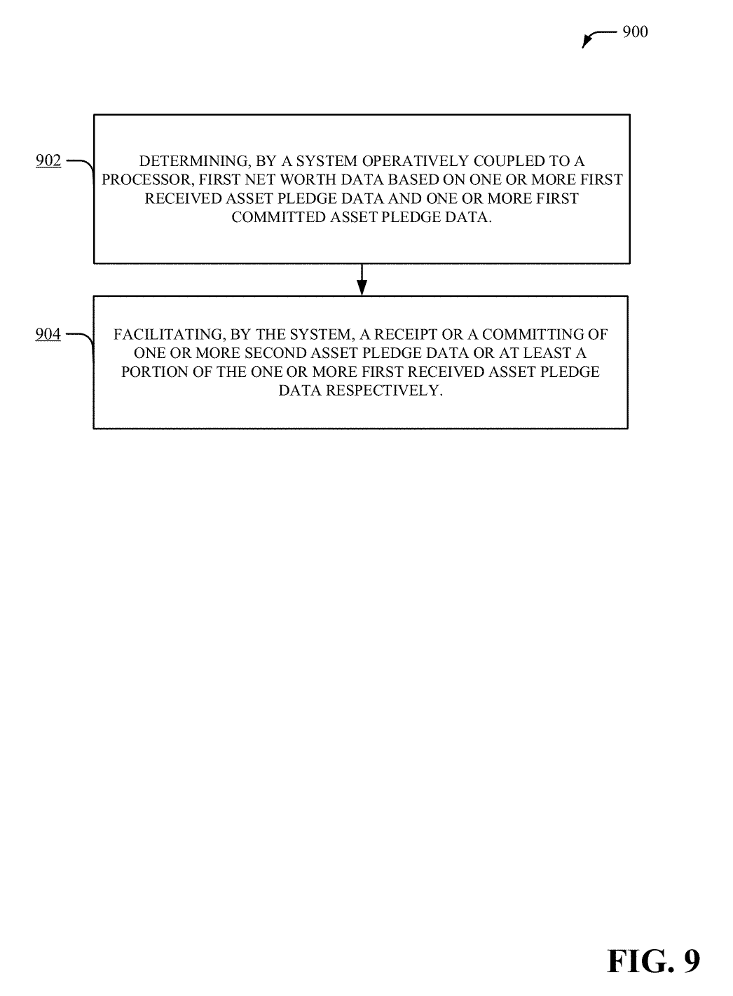

In view of the example systems and/or interface described herein, example methods that can be implemented in accordance with the disclosed subject matter can be further appreciated with reference to flowcharts in FIGS. 9-12. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

Turning now to FIG. 9 illustrated is a non-limiting computer implemented method example of a system 900 that can facilitate access to pledge data representing pledges of assets (e.g., guarantees or promises to assign an asset to a user in the event of an occurrence of an event such as to satisfy a default on a debt obligation) that can boost the users' creditworthiness or provide pledges to other users to increase such recipient users' creditworthiness. Repetitive description of like elements employed in respective embodiments of systems and interfaces described herein are omitted for sake of brevity. In some implementations, at reference numeral 902, a system operatively coupled to a processor (e.g., processor 112) can determine (e.g. using fist determination component 110) first net worth data based on one or more first received asset pledge data and one or more first committed asset pledge data. In another aspect, at reference numeral 904, the system can facilitate a receipt (e.g., using transfer component 120) of one or more second asset pledge data or a commitment of at least a portion of the one or more first received asset pledge data.

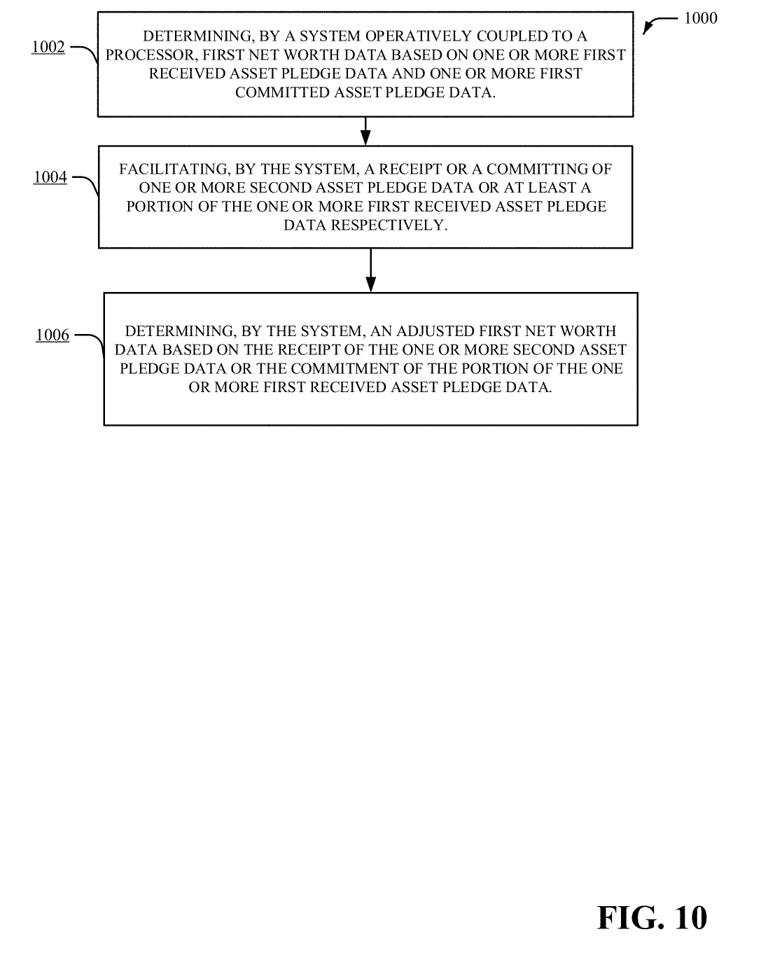

Turning now to FIG. 10 illustrated is a non-limiting computer implemented method example of a system 1000 that can facilitate access to pledge data representing pledges of assets (e.g., guarantees or promises to assign an asset to a user in the event of an occurrence of an event such as to satisfy a default on a debt obligation) that can boost the users' creditworthiness or provide pledges to other users to increase such recipient users' creditworthiness. Repetitive description of like elements employed in respective embodiments of systems and interfaces described herein are omitted for sake of brevity. In some implementations, at reference numeral 1002, a system operatively coupled to a processor (e.g., processor 112) can determine (e.g. using fist determination component 110) a first net worth based on one or more first received asset pledge and one or more first committed asset pledge. In another aspect, at reference numeral 1004, the system can facilitate a receipt (e.g., using transfer component 120) of one or more second asset pledge or a commitment of at least a portion of the one or more first received asset pledge. At 1006, the system can determine an adjusted first net worth based on the receipt of the one or more second asset pledge or the commitment of the portion of the one or more first received asset pledge.

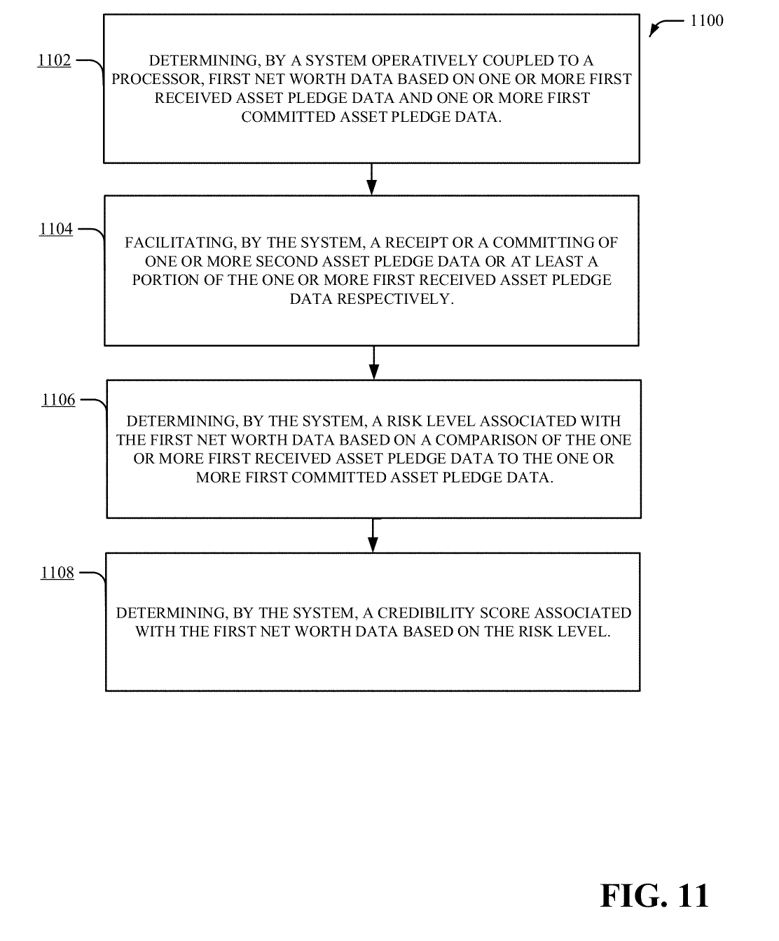

Turning now to FIG. 11 illustrated is a non-limiting computer implemented method example of a system 1100 that can facilitate access to pledge data representing pledges of assets (e.g., guarantees or promises to assign an asset to a user in the event of an occurrence of an event such as to satisfy a default on a debt obligation) that can boost the users' creditworthiness or provide pledge data to other users to increase such recipient users' creditworthiness. Repetitive description of like elements employed in respective embodiments of systems and interfaces described herein are omitted for sake of brevity. In some implementations, at reference numeral 1102, a system operatively coupled to a processor (e.g., processor 112) can determine (e.g. using fist determination component 110) first net worth data based on one or more first received asset pledge data and one or more first committed asset pledge data. In another aspect, at reference numeral 1104, the system can facilitate a receipt (e.g., using transfer component 120) of one or more second asset pledge data or a commitment of at least a portion of the one or more first received asset pledge data. At 1106, the system can determine (e.g., using risk determination component 410) a risk level associated with the first net worth data based on a comparison of the one or more first received asset pledge data to the one or more first committed asset pledge data. At 1108, the system can determine (e.g., using scoring component 510) a credibility score associated with the first net worth data based on the risk level (e.g., represented by risk data).

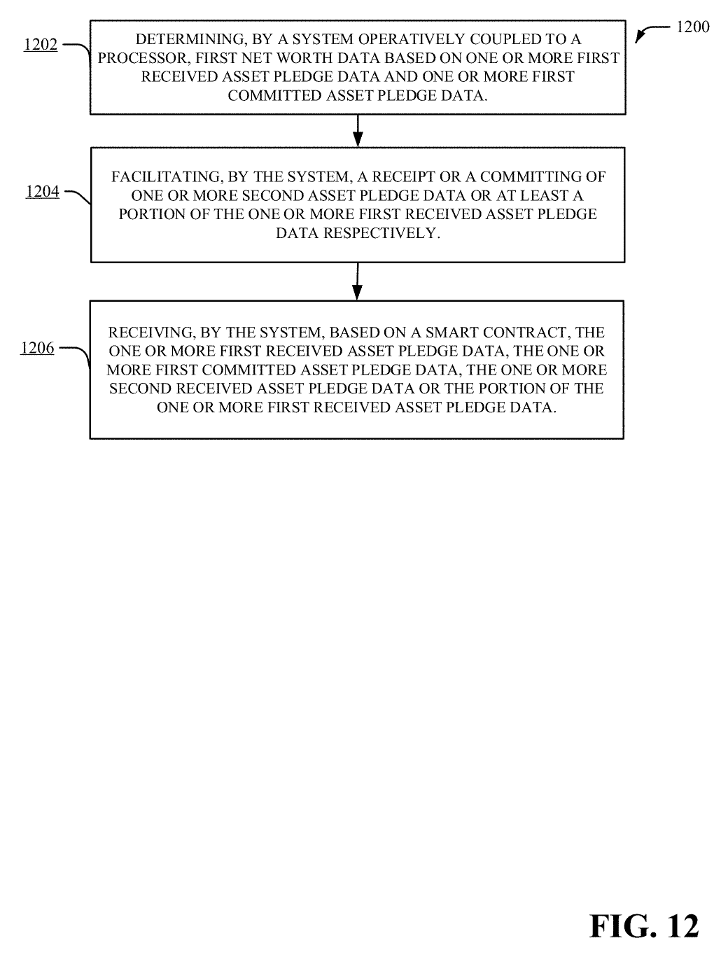

Turning now to FIG. 12 illustrated is a non-limiting computer implemented method example of a system 1200 that can facilitate access to pledge data representing pledges of assets (e.g., guarantees or promises to assign an asset to a user in the event of an occurrence of an event such as to satisfy a default on a debt obligation) that can boost the users' creditworthiness or provide pledges data to other users to increase such recipient users' creditworthiness. Repetitive description of like elements employed in respective embodiments of systems and interfaces described herein are omitted for sake of brevity. In some implementations, at reference numeral 1202, a system operatively coupled to a processor (e.g., processor 112) can determine (e.g. using fist determination component 110) first net worth data based on one or more first received asset pledge data and one or more first committed asset pledge data. In another aspect, at reference numeral 1204, the system can facilitate a receipt (e.g., using transfer component 120) of one or more second asset pledge data or a commitment of at least a portion of the one or more first received asset pledge data. At 1206, the system can receive (e.g., using management component 810) as per a respective arrangement the one or more first received asset pledge data, the one or more first committed asset pledge data, the one or more second received asset pledge data or the portion of the one or more first received asset pledge data.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art can understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Moreover, because connecting users and facilitating users to source pledges of worth and/or support from other users or provide pledges of worth and/or support to other users, and determining worth of users as well as values of such pledges is performed by components executed by a processor (e.g., processor 112) established from a combination of electrical and mechanical components and circuitry, a human is unable to replicate or perform the subject data packet configuration and/or the subject communication between processing components and/or a determination component. Furthermore, data associated with the system can be generated, transformed, and/or mapped to other systems (e g , banking systems, lending site systems, credit score systems, etc.). The access to such data can be accessed from a memory (e.g., using memory 108) where such access patterns a human are unable to replicate.

Also, the systems and methods disclosed herein can be integrated with the tangible and physical components of various devices (e.g., worth can be integrated into credit card technologies, smart phone devices, tablets, personal digital assistants, set top boxes, etc.). Furthermore, the determination of pledge value's and net worth value's as well as adjusted pledge value's and net worth values for various users and between users cannot be performed by a human. Furthermore, the simultaneous ability to coordinate sourcing and deployment of numerous pledges cannot be performed by a human. For example, a human is unable to generate pledges from many users at once and provide meaningful data associated with such pledges (e.g., values of pledges, the liquidity of the pledges, worth of other assets aside from the pledges, etc.), let alone do so accurately and precisely. Furthermore, a human is unable to communicate pledge data, valuation data, worth data, risk data and/or packetized data for communication between a main processor (e.g., using processor 118) and a memory (e.g., memory 108). Also, a human cannot assign a score to each user that is adjusted based on a multitude of factors and activities conducted by such user including receiving pledges, providing pledges, contributing assets to its worth, undertaking transactional obligations, and other such factors.

In various embodiments, the associated system components and devices disclosed herein can be pledge content analyzing computing systems associated with technologies, such as, but not limited to, computing technologies, network technologies, communication technologies, database technologies, data processing technologies (e.g., related to data capturing, extracting, mapping matching, inferring, mining, etc.), data management technologies (e.g., related to data acquisition, disposition, possession, use, inference, etc.), artificial intelligence technologies, and/or other digital technologies. The devices, systems and associated components can be employed to solve problems that are highly technical in nature (e.g., automated monitoring of pledge data, classification of pledged assets, processing of pledge data, automated inferencing of net worth data and creditworthiness based on pledge data, which can be related to the automatic facilitation of automated detection and use of pledge data in content communicated over a network, that are not abstract and that cannot be performed as a set of mental acts by a human.

For instance, a human could not automatically, (e.g., within a matter of seconds or less) analyze voluminous amounts of content frequently received over the Internet to accurately, effectively, efficiently, and consistently detect sensitive information used in content (e.g., pledge data) to determine whether a user has a net worth that authorizes them to perform a transaction and generate notifications of such net worth to other user devices. In an aspect, pledge data can be communicated using systems disclosed herein and the term “communicated” can include, but is not limited to, generating, transmitting, receiving, processing, tracking, rendering, conveying, impairing, sharing, exchanging, submitting, revealing, manifesting, spreading, connecting, and/or managing pledge data between one or more entity.

In an aspect, pledge data can be accessed by any of several user devices (e.g., client device, server device, user device, etc.). Furthermore, the pledge data can be structured in an efficient manner to allow for efficient and fast transmission of pledge data between one or more devices. Furthermore, in an aspect, the systems and system components disclosed herein can be executed by one or more processors and such processors can transmit, communicate and/or receive pledge data with other processors. In an aspect, the exchange of such pledge data can occur via a common information exchange that allows for a convergence of pledge data information that is interoperable between all processors. In an instance, pledge data representing a pledge of an intellectual property asset can be structured (e.g., by system components) to be utilized by one or more processor in the same manner that pledged asset data representing a precious metal can be structured. Accordingly, pledge data representing a wide spectrum of asset pledges can be interpreted in a standardized manner based on the systems disclosed herein.

Furthermore, such standardized pledge data can be executed in an efficient manner Also, such pledge data can be accessed in an efficient manner from memory due to the structure of such pledge data. In an aspect, pledge data can be stored in a referenceable data database in an organized manner that allows for faster searching and more effective data storage capabilities of a device components. For instance, pledge data can be stored in multiple data tables comprising common keys that allow data within the table to be related, identified, and accessed efficiently using pledge identification data (e.g., asset identifiers, pledge information, amount of pledged asset, users associated with such pledge data, etc.).

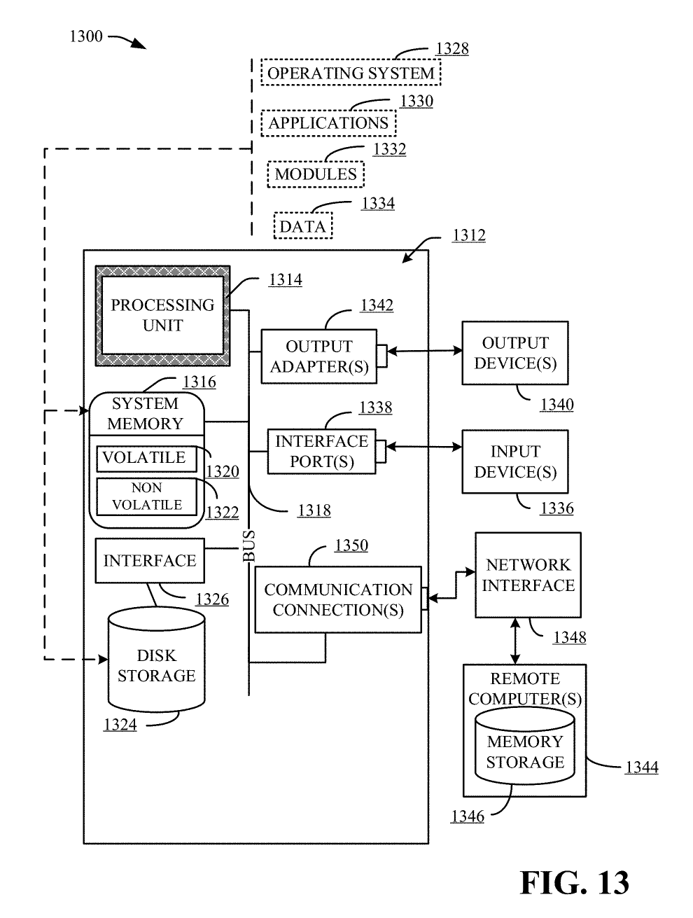

In order to provide a context for the various aspects of the disclosed subject matter, FIG. 13 as well as the following discussion is intended to provide a general description of a suitable environment in which the various aspects of the disclosed subject matter can be implemented. FIG. 13 illustrates a block diagram of an example, non-limiting operating environment in which one or more embodiments described herein can be facilitated. With reference to FIG. 13, a suitable operating environment 1300 for implementing various aspects of this disclosure can also include a computer 1312. The computer 1312 can also include a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314. The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1316 can also include volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1320 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1312 can also include removable/non-removable, volatile/non-volatile computer storage media. FIG. 13 illustrates, for example, a disk storage 1324. Disk storage 1324 can also include, but is not limited to, devices like a magnetic disk drive, floppy disk drive, tape drive, Jaz drive, Zip drive, LS-100 drive, flash memory card, or memory stick. The disk storage 1324 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1324 to the system bus 1318, a removable or non-removable interface is typically used, such as interface 1326. FIG. 13 also depicts software that acts as an intermediary between users and the basic computer resources described in the suitable operating environment 1300. Such software can also include, for example, an operating system 1328. Operating system 1328, which can be stored on disk storage 1324, acts to control and allocate resources of the computer 1312.

System applications 1330 take advantage of the management of resources by operating system 1328 through program modules 1332 and program data 1334, e.g., stored either in system memory 1316 or on disk storage 1324. It is to be appreciated that this disclosure can be implemented with various operating systems or combinations of operating systems. A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port can be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a computer, a server, a router, a network PC, a workstation, a microprocessor based appliance, a peer device or other common network node and the like, and typically can also include many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1350 refers to the hardware/software employed to connect the network interface 1348 to the system bus 1318. While communication connection 1350 is shown for illustrative clarity inside computer 1312, it can also be external to computer 1312. The hardware/software for connection to the network interface 1348 can also include, for exemplary purposes only, internal and external technologies such as, modems including regular telephone grade modems, cable modems and DSL modems, ISDN adapters, and Ethernet cards.

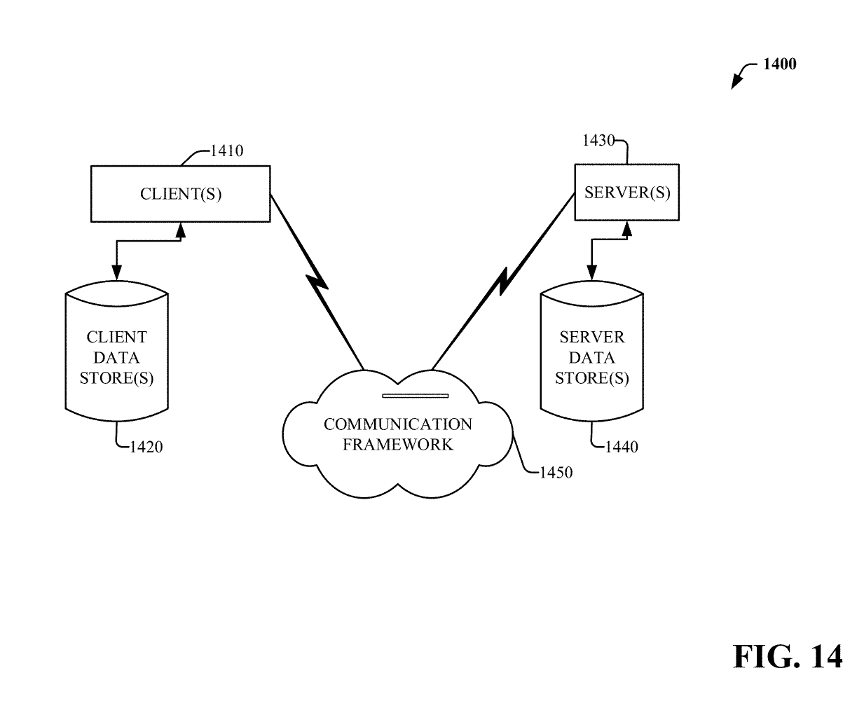

Referring now to FIG. 14, there is illustrated a schematic block diagram of a computing environment 1400 in accordance with this disclosure. The system 1400 includes one or more client(s) 1402 (e.g., laptops, smart phones, PDAs, media players, computers, portable electronic devices, tablets, and the like). The client(s) 1402 can be hardware and/or software (e.g., threads, processes, computing devices). The system 1400 also includes one or more server(s) 1404. The server(s) 1404 can also be hardware or hardware in combination with software (e.g., threads, processes, computing devices). The servers 1404 can house threads to perform transformations by employing aspects of this disclosure, for example. One possible communication between a client 1402 and a server 1404 can be in the form of a data packet transmitted between two or more computer processes wherein the data packet may include video data. The data packet can include a metadata, e.g., associated contextual information, for example. The system 1400 includes a communication framework 1406 (e.g., a global communication network such as the Internet, or mobile network(s)) that can be employed to facilitate communications between the client(s) 1402 and the server(s) 1404.

Communications can be facilitated via a wired (including optical fiber) and/or wireless technology. The client(s) 1402 include or are operatively connected to one or more client data store(s) 1408 that can be employed to store information local to the client(s) 1402 (e.g., associated contextual information). Similarly, the server(s) 1404 are operatively include or are operatively connected to one or more server data store(s) 1410 that can be employed to store information local to the servers 1404. In one embodiment, a client 1402 can transfer an encoded file, in accordance with the disclosed subject matter, to server 1404. Server 1404 can store the file, decode the file, or transmit the file to another client 1402. It is to be appreciated, that a client 1402 can also transfer uncompressed file to a server 1404 and server 1404 can compress the file in accordance with the disclosed subject matter. Likewise, server 1404 can encode video information and transmit the information via communication framework 1406 to one or more clients 1402.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “of” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” “data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory that stores computer executable components;
a processor that executes the computer executable components stored in the memory, wherein the computer executable components comprise:
a first determination component that determines first net worth data based on one or more first received asset pledge data and one or more first committed asset pledge data; and
a transfer component that facilitates a receipt of one or more second asset pledge data or a provisioning of at least a portion of the one or more first received asset pledge data.

2. The system of claim 1, further comprising a second determination component that determines an adjusted first net worth data based on the receipt of the one or more second asset pledge data or the commitment of the portion of the one or more first received asset pledge data.

3. The system of claim 1, further comprising a pledging component that facilitates a provisioning of at least a portion of the first net worth data in exchange for asset data representing an item of value.

4. The system of claim 1, wherein the one or more first received asset pledge data or the one or more first committed asset pledge data represents at least one of a first pledge of collateral, a second pledge of an asset, a third pledge of a guarantee, a fourth pledge of an economic interest, a fifth pledge of cash, a sixth pledge of liability assumption, or a seventh pledge of property.

5. The system of claim 1, further comprising a risk determination component that determines a risk level associated with the first net worth data based on a comparison of the one or more first received asset pledge to the one or more first committed asset pledge.

6. The system of claim 1, further comprising a scoring component that determines a credibility score associated with the first net worth based on the risk level.

7. The system of claim 3, further comprising a preference component that facilitates a selection of one or more pledge feature data from a set of pledge feature data, wherein the set of pledge feature data represents at least one of a pledge limit, an asset class associated with a proposed pledge, a pledge hierarchy, a joint liability pledge, or a several liability pledge.

8. The system of claim 1, further comprising a valuation component that assigns a first value to the one or more first received asset pledge data, a second value to the one or more first committed asset pledge data, a third value to the one or more second received asset pledge data and a fourth value to the portion of the one or more first received asset pledge data, wherein the first net worth data is based in part on the first value and the second value.

9. The system of claim 1, further comprising a management component that transmits to a management account based on a smart contract, the one or more first received asset pledge data, the one or more first committed asset pledge data, the one or more second received asset pledge data or the portion of the one or more first received asset pledge data.

10. The system of claim 9, wherein the management account represents at least one of a custodian account, a record system, a reserve account, an agency account, a borrower-in-custody arrangement, a custodian arrangement, a deposit account, or an escrow account.

11. A method comprising,
determining, by a system comprising a processor, a first net worth data based on one or more first received asset pledge data and one or more first committed asset pledge data; and
facilitating, by the system, a receipt or a commitment of one or more second asset pledge data or at least a portion of the one or more first received asset pledge data respectively.

12. The method of claim 11, further comprising determining, by the system, an adjusted first net worth data based on the receipt of the one or more second asset pledge data or the commitment of the portion of the one or more first received asset pledge data.

13. The method of claim 11, further comprising a facilitating, by the system, a pledge of at least a portion of the first net worth data in exchange for an item of value.

14. The method of claim 11, further comprising determining, by the system, a risk level associated with the first net worth data based on a comparison of the one or more first received asset pledge data to the one or more first committed asset pledge data.

15. The method of claim 11, further comprising determining, by the system, a credibility score associated with the first net worth data based on the risk level.

16. The method of claim 13, further comprising facilitating, by the system, a selection of one or more pledge data feature data from a set of pledge feature data, wherein the set of pledge feature data represents at least one of a pledge limit, an asset class associated with a proposed pledge, a pledge hierarchy, a joint liability pledge, or a several liability pledge.

17. The method of claim 11, further comprising assigning, by the system, a first value to the one or more first received asset pledge data, a second value to the one or more first committed asset pledge data, a third value to the one or more second received asset pledge data and a fourth value to the portion of the one or more first received asset pledge data, wherein the first net worth data is based in part on the first value and the second value.

18. The method of claim 11, further comprising receiving, by the system, as per a respective arrangement the one or more first received asset pledge data, the one or more first committed asset pledge data, the one or more second received asset pledge data or the portion of the one or more first received asset pledge data.

19. The method of claim 11, further comprising a legal component that facilitates an occurrence of a legal mechanism to execute the received asset pledge data or the first committed asset pledge data as a binding agreement.

20. The computer program product of claim 18, wherein the program instructions are further executable by the processor to cause the processor to:
determine a first net worth based on one or more first received asset pledge data and one or more first committed asset pledge data; and
facilitate a receipt of one or more second asset pledge data or a commitment of at least a portion of the one or more first received asset pledge data.
